(19) United States
(12) Patent Application Publication
(10) Pub. No.: US 2015/0202108 A1
(43) Pub. Date: Jul. 23, 2015

(54) Urn Cover

(71) Applicant: Julie Kilian, Levittown, PA (US)

(72) Inventor: Julie Kilian, Levittown, PA (US)

(21) Appl. No.: 14/600,404

(22) Filed: Jan. 20, 2015

Related U.S. Application Data
(60) Provisional application No. 61/930,172, filed on Jan. 22, 2014.

(51) Int. Cl. A61G 99/00; B65D 33/12; A61G 17/08; B65D 33/00

(52) U.S. Cl. CPC A61G 99/00; B65D 33/004; B65D 33/12; A61G 17/08

(57) ABSTRACT

The present embodiment is a funerary accessory that serves as a ceremonial urn cover and/or carrier for cremated remains. A key benefit of the ceremonial cover is its ability to accommodate a great deal of personalization. A discreet pocket on the back of the bag allows for notes and/or mementos to be interred with the deceased. An accent band encircling the cover serves as a back drop for an oversized locket, a photograph or military metals; anything the decedent's family chooses to remember the life of their loved one. To aid in transporting the urn box without soiling, a handle is provided.

### CROSS-REFERENCE TO RELATED APPLICATION

This application claims the benefits of provisional patent application Ser. No. 61/930,172, filed 2014 Jan. 22 by the present inventor.

### BACKGROUND

The present invention is in the field of funerary textile goods.

For millennia humans have buried their dead with tokens of respect and remembrance. Even today, mourners often place keepsakes inside of caskets as an expression of reverence for the departed. This final gesture of farewell plays an important role in the grieving process and helps provide closure for the mourners. As modern society continues the trend toward cremation and caskets are replaced by urns, the opportunity to make a final, physical connection with a loved one is lost and the opportunity to include photographs, tokens, and written sentiments for interment is absent.

The recent popularity of the life-affirming funeral means that families are looking for ways to personalize the memorial service to remember and honor their loved one's life. While many urns may be engraved, they do not offer the ability to enclose or attach personal items such as a photograph, military honors, jewelry or other item that might reflect the personality, interests and achievements of the decedent.

In addition, it is standard practice for the crematory to deliver the remains in a generic plastic container. A ceremonial display of the ashes currently requires the family to transfer the remains to an ornamental urn, a task that many are uncomfortable performing. The ornamental urns of today typically provide no mechanism for transporting the remains without handling the container. This exposes the urn to soiling and damage. Also, the closure on many urns is insufficient to prevent a spill should the urn be dropped or mishandled.

### SUMMARY

In accordance with one embodiment an urn cover comprises a textile item that is configured in two parts: an inner sheath and an outer casing. The inner sheath fits over an upright urn, securing the lid and covering the sides of a generic plastic container. The outer casing provides a surface for ceremonial ornamentation and personalization, a pocket for the storage of keepsakes and mementos, and a handle to minimize damage during transport. The urn cover serves as a carrier and/or vestment that renders a generic urn suitable for funerary display.

### DRAWINGS

### Figures

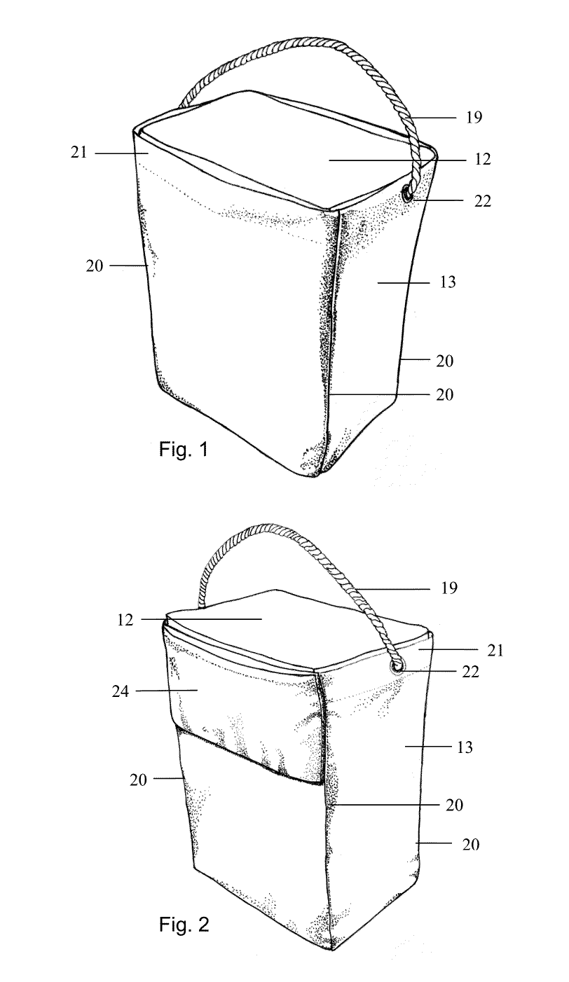

FIG. 1 is a perspective view of one embodiment showing the fully assembled front, top and right facing side.

FIG. 2 is a perspective view of one embodiment showing the fully assembled back, top and left facing side.

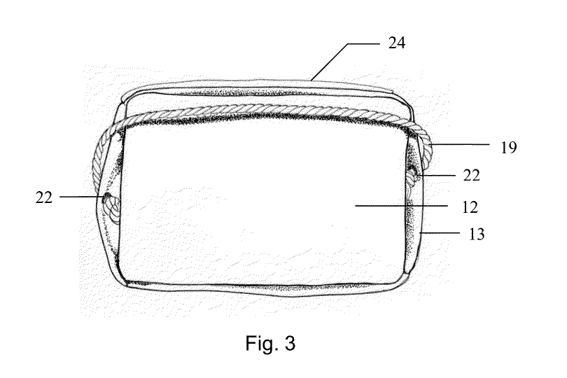

FIG. 3 is a plan view of one embodiment showing the fully assembled cover.

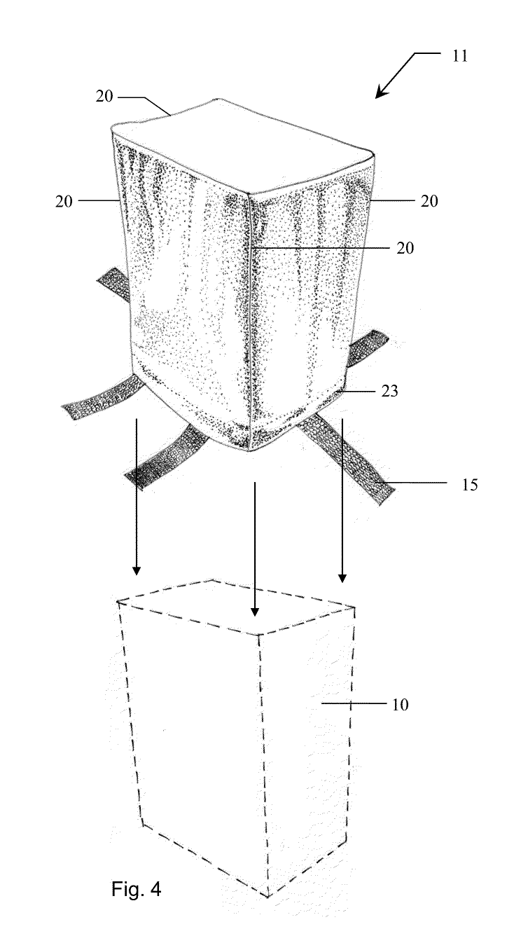

FIG. 4 is a perspective view of one embodiment showing the inner sheath in relation to a generic urn.

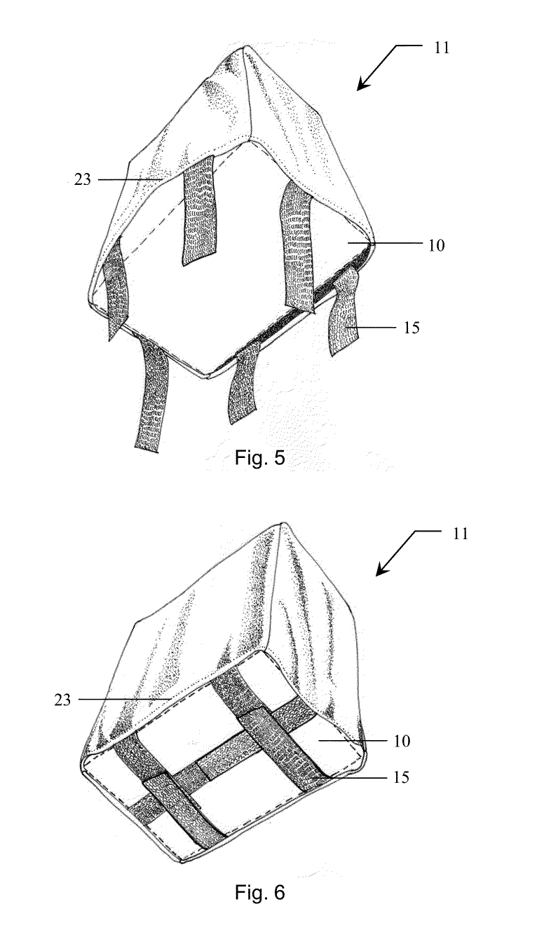

FIG. 5 is a perspective view of one embodiment showing the inner sheath placed over a generic urn, as viewed from below.

FIG. 6 is a perspective view of one embodiment showing the inner sheath placed over a generic urn, with hook-and-loop straps in the fastened position, as viewed from below.

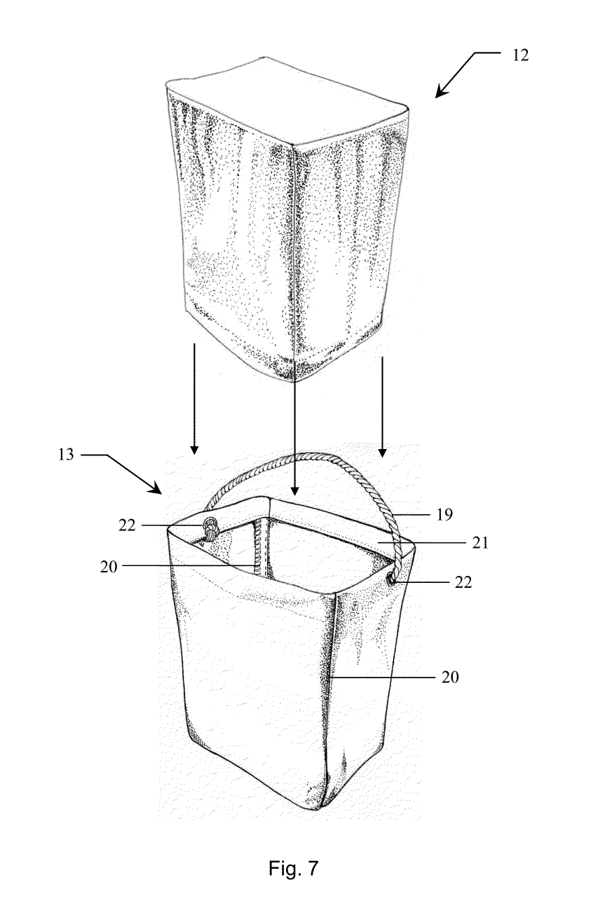

FIG. 7 is a perspective view of one embodiment showing the sheathed urn in relation to the outer casing.

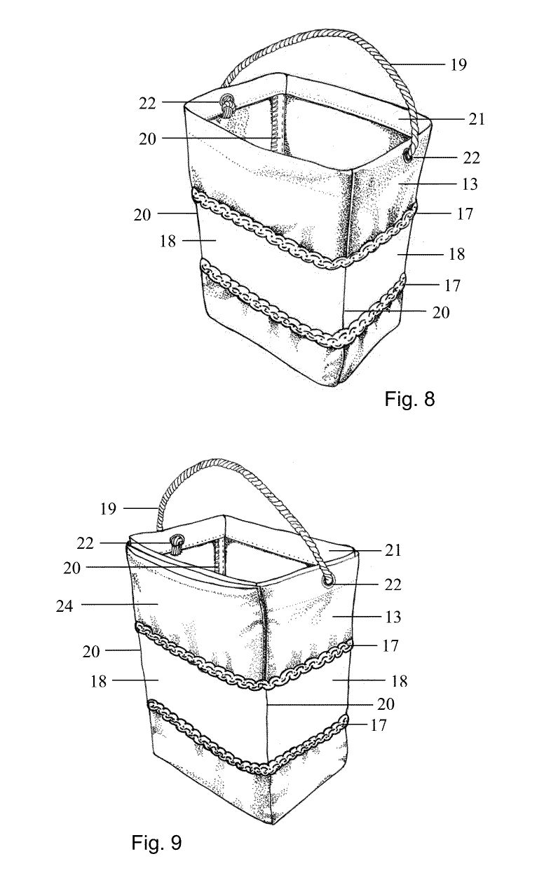

FIG. 8 is a perspective view of an additional embodiment showing the front of the outer casing with an integral accent band.

FIG. 9 is a perspective view of an additional embodiment showing the back of the outer casing with an integral accent band.

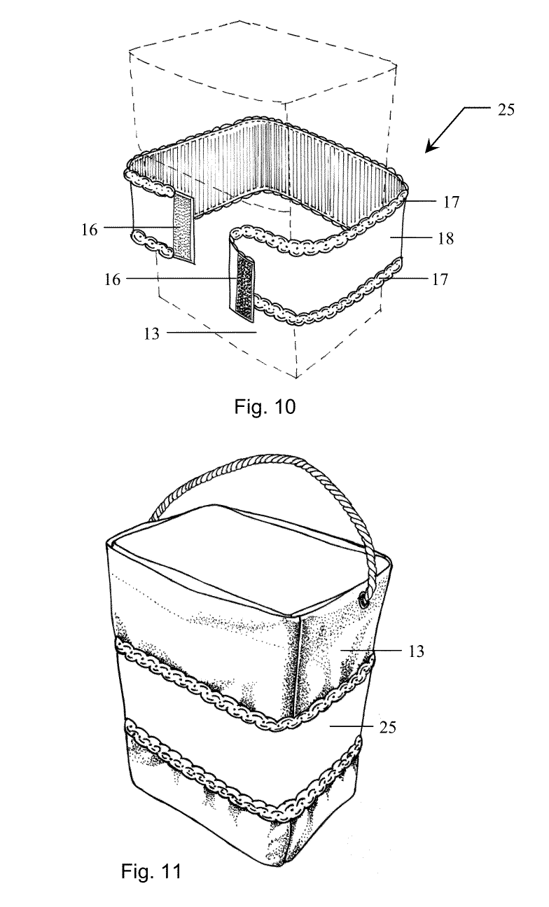

FIG. 10 is a perspective view of an alternative embodiment showing a detachable accent band in relation to the outer casing.

FIG. 11 is a perspective view of an alternative embodiment showing a fully assembled urn cover with detachable accent band.

### DRAWINGS

### Reference Numerals

| | |
|---|---|
| 10 generic urn | 11 inner sheath |
| 12 sheathed urn | 13 outer casing |
| 15 hook-and-loop strap | 16 hook-and-loop tab |
| 17 trim | 18 accent ribbon |
| 19 cording | 20 seam |
| 21 casing hem | 22 grommet |
| 23 sheath hem | 24 pocket |
| 25 accent band | |

### DETAILED DESCRIPTION

### First Embodiment

As represented in FIG. 1, FIG. 2 and FIG. 3, the first embodiment is shown fully assembled. Referring to FIG. 1, what may be considered the front of the first embodiment is shown. The outer casing 13 serves as a surface on which to display a photo, locket, military metal, or other memento that memorializes the departed. What may be considered the back of the first embodiment is represented in FIG. 2. The key feature of note is the pocket 24. Note cards, photos, mementos, etc. may be stored in the pocket 24 for interment with the urn. FIG. 3 shows a top view of the fully assembled first embodiment. The top of the sheathed urn 12 is visible.

FIGS. 4, 5, 6, and 7 illustrate the components of the first embodiment. Referring to FIGS. 4, 5, 6, the inner sheath 11 is constructed from a predetermined number of fabric panels configured to form a five sided vestment. All seams 20 are sewn using an overlock stitch. The bottom of the inner sheath 11 is open and finished with a hem 23. To prevent the inner sheath 11 from sliding off of the generic urn 10, hook-and-loop straps 15 are attached at the hem 23. The length of each hook-and-loop strap 15 is sufficient to overlap and fasten together. The number and placement of the hook-and-loop straps 15 is sufficient so as to minimize puckering and stressing of the inner sheath 11 when fastened. Each hook-and-loop strap 15 extends approximately 1¼″ inside the inner sheath 11 and is attached by two rows of stitches placed 1″ in from the finished edge and ¼″ in from the finished edge, respectively.

Referring to FIG. 7, the outer casing 13 is constructed from a predetermined number of fabric panels configured to form a five-sided vestment, two grommets 22, one piece of cording 19 and one pocket 24. All seams 20 are sewn using an overlock stitch. The top of the outer casing 13 is open and finished with a hem 21. A grommet 22 is attached at the top of each of two opposing sides. The cording 19 is cut to a length sufficient to form a handle that does not obstruct the outer casing 13 opening. The ends of the cording 19 are treated to prevent unraveling. The cording 19 is passed through the grommets 22 and the ends are knotted to prevent the cording 19 from passing back through the grommets 22. In this fashion a handle is formed and the first embodiment functions as a carrier.

As shown in FIG. 2, the pocket 24 is made from a single layer of fabric. The top edge of the pocket 24 is hemmed. The pocket 24 is attached to the outer casing 13 along the side and bottom edges of the pocket. The top edge of the pocket 24 remains open to allow access to the pocket interior.

### Operation

The following method of assembly applies to all embodiments. Referring to FIGS. 4, 5, and 6 the inner sheath 11 is shown to fit over a generic urn 10. FIG. 6 shows the hook-and-loop straps 15 fastened across the bottom of the generic urn 10. The generic urn 10 and inner sheath 11 are assembled and ready for placement into the outer casing 13. FIG. 7 shows the placement of the sheathed urn 12 into the outer casing 13.

### Additional Embodiments

FIGS. 8 and 9 show a decorative band incorporated into the outer casing 13. The outer casing 13 is constructed from four fabric side panels, one fabric bottom panel, four pieces of accent ribbon 18, two pieces of trim 17, two grommets 22, one piece of cording 19 and one pocket 24. The four side panels are attached to the bottom panel using an overlock stitch. The bottom edge of each piece of ribbon 18 is placed a proportional distance above the bottom seam and attached to each respective side piece. Three of the four vertical side seams 20 are sewn using an overlock stitch capturing the cut ends of the ribbon 18. A length of trim 17 is applied along the top and bottom edges of the accent ribbon 18 with the cut ends terminating at the open seam. The remaining vertical seam 20 is sewn using an overlock stitch, capturing the ends of the ribbon 18 and trim 17. As with the first embodiment, the top of the outer casing 13 is open and finished with a hem 21. A grommet 22 is placed at the top of two opposing side panels. The cording 19 is cut to a length sufficient to form a handle that does not obstruct the outer casing 13 opening. The cut ends of the cording 19 are treated to prevent unraveling. The cording 19 is passed through the grommets 22 and the ends are knotted to secure the handle.

As shown in FIG. 9, the pocket 24 is made from a single layer of fabric. The top edge of the pocket 24 is hemmed. The pocket 24 is attached to the outer casing 13 along the side and bottom edges of the pocket. The top edge of the pocket 24 remains open to allow access to the pocket interior.

### Alternative Embodiments

As shown in FIGS. 10 and 11, the outer casing is embellished with a detachable accent band 25. The accent band 25 is of a length that encircles the outer casing 13 and allows for overlapping of the ends. The accent band 25 is constructed of a single length of accent ribbon 18 and two lengths of trim 17. Each piece of trim 17 is sewn onto the accent ribbon 18 along each of the ribbon's longitudinal edges. A hook-and-loop tab 16 is placed on one end of the front side of the accent band 25 with the hook side facing outward. A coordinating hook-and-loop tab 16 is placed on the back side of the opposite end of the accent band 25 with the loop side facing inward. The accent band 25 is placed around the outer casing 13, pulled taut and secured by fastening the hook-and-loop tabs 16.

### CONCLUSIONS, RAMIFICATIONS, AND SCOPE

While the above description contains many specifics, these should not be construed as limitations on the scope, but rather as an exemplification of one or several possible embodiments. For example variations are possible with regard to shape, size, construction method, material, and detailing. Generic urns are available in a variety of sizes and shapes making it necessary to alter the urn cover to fit. Shapes include, but not limited to, rectangular, cylindrical, square, etc. Urns also vary in size from small to extra-large. Modifications may be made due to factors and/or considerations such as ease of fabrication, cost of fabrication, availability of materials, and aesthetics. As circumstances dictate, features such as number of seams, type of stitching, etc. may also be subject to modification. Furthermore, variations in material, color and dimension can be applied to the detachable accent band as a means of personalizing the urn cover. Accordingly, the scope should be determined not by the embodiments illustrated, but by the appended claims and their legal equivalents.

I claim:

1. A textile item, comprising: a sheath element and a casing element, wherein the sheath element is placed concentrically within the casing element.

2. The sheath of claim 1 wherein the sheath is composed of textile material configured to form a five-sided vestment, wherein the vestment exhibits a sixth open side, whereby the vestment may be placed over a container.

3. The open side of claim 2 is obstructed by means of transverse hook-and-loop straps, whereby the container is secured within the sheath.

4. The open side of claim 3 is obstructed by means of elastic strap.

5. The open side of claim 3 is obstructed by means of fabric straps fitted with snaps.

6. The casing of claim 1 wherein the casing is composed of textile material configured to form a five-sided vestment, wherein the vestment exhibits a sixth open side, whereby the casing may receive a sheathed container.

7. The casing of claim 6 whereby tributes are displayed by means of pinning and/or sewing objects onto the casing.

8. The open side of claim 6 is traversed by a cord which is passed through a plurality of grommets placed on opposing sides of the opening, wherein the cord is knotted on both ends, whereby the cording is pulled taut to form a handle.

9. The handle of claim 8 whereby the casing may be lifted and carried.

10. A measure of fabric applied to the outer surface of the casing, whereby a pocket is formed.

11. The pocket of claim 10 is fastened to the outer surface of the casing by means of sewing or gluing.

12. The pocket of claim 10 is closed by means of mechanical fastener.

13. The pocket of claim 10 is closed by means of a flap.

14. A predetermined length of trimming applied to the outer surface of the casing and encircling the casing whereby the casing is embellished.
